(19) United States
(12) Patent Application Publication
(10) Pub. No.: US 2025/0027905 A1
(43) Pub. Date: Jan. 23, 2025

(54) DEVICE FOR MEASURING THE OXIDATION OF A BRAKE DISC BY MEANS OF DIAMAGNETISM MEASUREMENT

(71) Applicants: SAFRAN ELECTRONICS & DEFENSE, Paris (FR); SAFRAN LANDING SYSTEMS, Velizy-Villacoublay (FR)

(72) Inventors: Nicolas Lipari, Moissy Cramayel (FR); Blaise Lapôtre, Moissy Cramayel (FR); Clément Sire, Moissy Cramayel (FR); Nicolas Fanton, Moissy Cramayel (FR); Emmanuel Couturier, Moissy Cramayel (FR)

(73) Assignees: SAFRAN ELECTRONICS & DEFENSE, Paris (FR); SAFRAN LANDING SYSTEMS, Velizy-Villacoublay (FR)

(21) Appl. No.: 18/716,507

(22) PCT Filed: Dec. 5, 2022
(86) PCT No.: PCT/FR2022/052243

§ 371 Date: Jun. 4, 2024

(30) Foreign Application Priority Data
Dec. 7, 2021 (FR) FR2113088

(51) Int. Cl. G01N 27/82; B60T 17/22; F16D 66/00

(52) U.S. Cl. CPC G01N 27/82; B60T 17/22; F16D 66/00; F16D 2066/006

(57) ABSTRACT

The invention relates to a device for measuring the oxidation of an element comprising a carbon-carbon composite, including a means for measuring the diamagnetism of the element and a means for converting the diamagnetism measurement into an oxidation measurement.

### TECHNICAL FIELD

The present invention relates to aircraft brake systems, and in particular to brake discs made of carbon-carbon composite material.

More particularly, the present invention relates to the measurement of oxidation of these carbon-carbon composite brake discs.

However, the present invention can be applied to any measurement of oxidation of a carbon-carbon composite material.

### PRIOR ART

Aircraft brake discs are regularly subjected to high temperatures, for example in excess of 700° Celsius. These high temperatures favor oxidation of carbon-carbon composite materials, often used in the composition of brake discs. In particular, oxidation can be more or less significant depending on the temperatures reached, or on the operating cycles of the brakes and their cooling, or even on the environment of the brake discs, in particular humidity or the presence of corrosive products.

Oxidation of a brake disc leads to more rapid wear of the brake discs, and is therefore detrimental to the aircraft's braking performance and disc service life. It is therefore important to be able to monitor the state of oxidation of the brake discs so as to be able to perform predictive maintenance and/or replacement of the brake discs.

One solution for measuring oxidation is to visually check brake disc wear. However, quantifying the level of oxidation is uncertain, and two different brake discs will not necessarily show the same wear marks for a same level of oxidation.

Another solution is to measure the circumference of a brake disc, as oxidation causes the circumference of brake discs to decrease and wear due to braking causes the thickness of brake discs to decrease.

However, measuring the circumference of a brake disc does not make it possible to monitor the course of oxidation of a brake disc. Indeed, the reduction in circumference only becomes measurable and visible when the brake disc is already too oxidized and needs to be replaced. This solution therefore does not allow predictive maintenance of brake discs.

In addition, this solution requires access to a brake disc, implying that the rim and tire have to be removed once the braking system has cooled down.

### DISCLOSURE OF THE INVENTION

The purpose of the present invention is therefore to overcome the aforementioned drawbacks and to provide a device for non-destructive measurement of oxidation, which will ultimately make it possible to identify the causes accelerating oxidation.

One object of the present invention is a device for measuring oxidation of an element comprising a carbon-carbon composite, the device comprising a means for measuring diamagnetism of the element and a means for converting the diamagnetism measurement into an oxidation measurement.

Thus, the oxidation measurement is reproducible and reliable, and utilizes the diamagnetic property of the carbon-carbon composite.

In one embodiment of the invention, the element is a brake disc.

Advantageously, the diamagnetism measurement means comprises a first coil to be placed in proximity to the element and a power supply supplying the first coil in order to generate a magnetic field.

Advantageously, the diamagnetism measurement means comprises a second coil to be placed in proximity to the element and comprising a first and a second terminal, and a means for measuring and integrating the voltage between the first terminal of the second coil and a reference terminal so as to measure the variations in magnetic field induced by the element.

Advantageously, the diamagnetism measurement means comprises a guide comprising a ferromagnetic material, the guide guiding the magnetic field generated by the first coil between said first coil and the element, as well as between the element and the second coil.

Advantageously, the first and second coils are coaxial.

In one particular embodiment, the reference terminal is the second terminal of the second coil.

In another particular embodiment, the diamagnetism measurement means further comprises a third coil and a fourth coil intended to be moved away from the element, each of the coils comprising two terminals, the second terminal of the second coil being connected to the first terminal of the third coil, the second terminal of the third coil being the reference terminal, the power supply being connected on the one hand to the first terminal of the first coil and on the other hand to the first terminal of the fourth coil, the second terminals of the first and fourth coils being connected.

In another embodiment, the diamagnetism measurement means comprises a magnet and/or electromagnet and a scale, the element being intended to be placed on the scale above said magnet and/or electromagnet so that the mass measured by the scale is correlated to the diamagnetism of the element by comparing the weight of a measured element with its weight when subjected to a magnetic field.

Advantageously, the means for converting the diamagnetism measurement into an oxidation measurement comprises an empirical conversion footprint and/or a theoretical or empirical law establishing an equivalence between diamagnetism of the element and oxidation of the element.

Another object of the present invention is a method for measuring oxidation of an element comprising a carbon-carbon composite with a device as previously defined, the method comprising the following steps of:
calibrating the device with a non-oxidized element and a highly oxidized element;
moving the device closer to the element;
activating the diamagnetism measurement means; and
converting the diamagnetism measurement into an oxidation measurement.

### BRIEF DESCRIPTION OF THE DRAWINGS

Further purposes, characteristics and advantages of the invention will become apparent upon reading the following description, given solely by way of non-limiting example of the invention, and made with reference to the appended drawings in which:

FIG. 1 illustrates a schematic cross-section of a device for measuring oxidation of an element according to the invention in a first embodiment;

FIG. 2 illustrates an alternative to the embodiment illustrated in FIG. 1;

FIG. 3 is a graph illustrating an example of an empirical footprint for connecting a diamagnetism measurement to an oxidation measurement;

FIG. 4 illustrates a schematic cross-section of a device for measuring oxidation of an element according to the invention in an alternative to the first embodiment illustrated in FIG. 1;

FIG. 5 illustrates a schematic cross-section of a device for measuring oxidation of an element according to the invention in a second embodiment;

FIG. 6 illustrates a schematic cross-section of a device for measuring oxidation of an element according to the invention in a third embodiment;

FIG. 7 illustrates a schematic cross-section of a device for measuring oxidation of an element according to the invention in a fourth embodiment;

FIG. 8 illustrates a schematic cross-section of a device for measuring oxidation of an element according to the invention in a fifth embodiment; and

FIG. 9 illustrates a method for measuring oxidation of an element according to the invention.

### DETAILED DISCLOSURE OF AT LEAST ONE EMBODIMENT

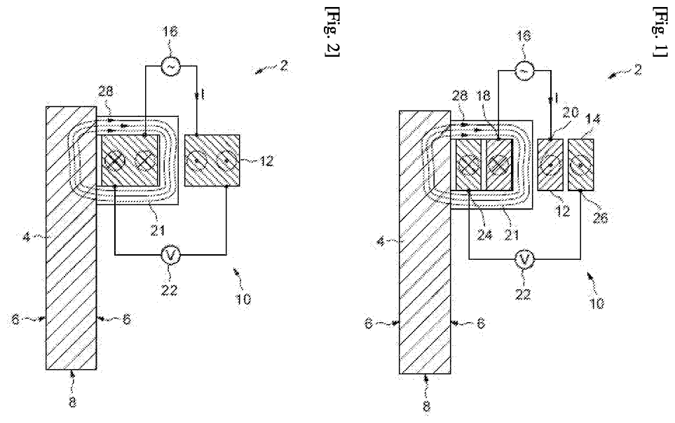

FIG. 1 represents a schematic view of a device 2 for measuring oxidation of an element 4 in a first embodiment.

In each embodiment represented, the element 4 is an aircraft brake disc comprising two parallel circular faces 6 and a cylindrical edge 8. The element 4 comprises a carbon-carbon composite comprising pyrocarbon, also known as pyrolytic carbon, whose matrix disintegrates due to oxidation. A particular property of pyrocarbon is its high diamagnetism, which has been observed to be more significant with a large amount of pyrocarbon, and therefore less significant when the pyrocarbon is oxidized.

In the first embodiment illustrated in FIG. 1, the device 2 comprises a means 10 for measuring diamagnetism of the element 4 and a means for converting the diamagnetism measurement into an oxidation measurement (not represented).

Thus, the diamagnetism measurement means 10 makes it possible to indirectly determine the amount of carbon-carbon composite by measuring diamagnetism in the element 4. The means for converting the diamagnetism measurement into an oxidation measurement then enables the diamagnetism measurement to be converted into an oxidation measurement. For example, the conversion means comprises a table or a curve footprint, for example obtained empirically, on which equivalences between diamagnetism and oxidation are listed for a given amount of carbon-carbon composite. Alternatively, or in addition to the table or curve, a theoretical or empirical law can be used to establish the equivalence between diamagnetism and oxidation of the element. The diamagnetism measurement means 10 comprises in particular a first coil 12 and a second coil 14, both intended to be placed in proximity to the element 4 in order to perform a diamagnetism measurement.

The diamagnetism measurement means 10 further comprises a power supply 16, for example a sinusoidal power supply, supplying the first coil 12 from an intensity I. In the embodiment illustrated in FIG. 1, the sinusoidal power supply 16 is connected on the one hand to a first terminal 18 of the first coil 12, and on the other hand to a second terminal 20 of the first coil 12. This architecture makes it possible to generate a magnetic field 21 from the first coil 12. The diamagnetism measurement means 10 also comprises a means 22 for measuring and integrating the voltage between the first terminal 24 of the second coil 14 and a reference terminal, here the reference terminal being the second terminal 26 of the second coil 14.

When the first coil 12 is sufficiently close to the element 4, the magnetic field 21 generated passes into the element 4, which distorts the shape of the magnetic field 21. The second coil 14 is intended to be placed so that the magnetic field 21 passes inside the second coil 14. Measuring the voltage across the second coil 14 and then integrating this measurement makes it possible to find the differences between the magnetic field emitted by the first coil 12 and the magnetic field received by the second coil 14.

In particular, the less the element 4 is oxidized, the stronger the diamagnetism will be and will oppose the magnetic field 21. In addition, the shape of the magnetic field 21 can also be modified, for example sinusoidal at the output of the first coil 12 and distorted when the second coil 14 is measured.

Optionally, the diamagnetism measurement means 10 comprises a guide 28 for guiding the magnetic field 21 directly between the first coil 12 and the element 4, as well as between the element 4 and the second coil 14. The guide 28 is for example made of ferromagnetic material. It comprises iron and/or nickel, for example.

In the embodiment illustrated, the first coil 12 is coaxial with the second coil 14. More particularly, the first coil 12 is located inside the second coil 14. This architecture enables the magnetic field 21 to be measured where it is emitted. Alternatively, the two coils 12 and 14 can be nested inside each other, or have a completely different configuration.

In FIG. 1, the device 2 illustrated enables the diamagnetism of element 4 to be measured by causing the magnetic field 21 to enter and exit at one and the same circular face 6 of the element 4.

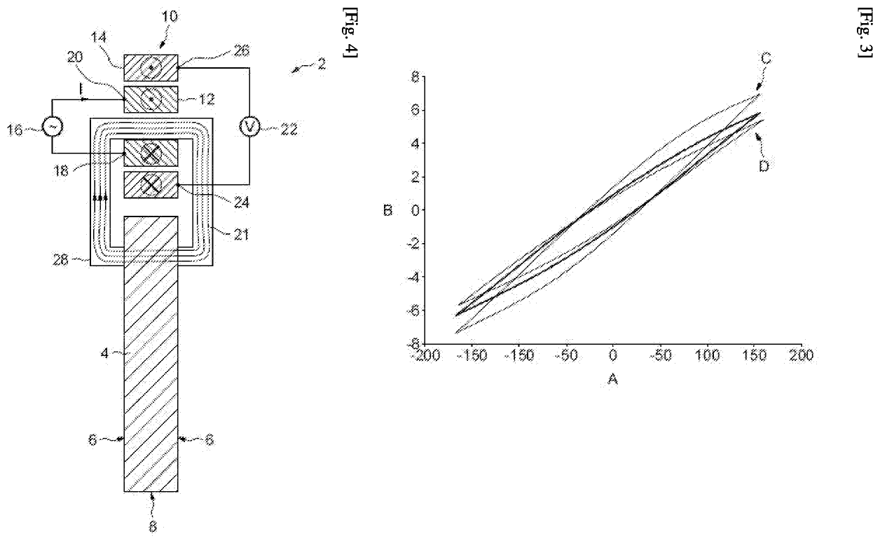

FIG. 2 represents an alternative to the embodiment illustrated in FIG. 1, with the first coil 12 and the second coil 14 combined into one and the same first coil 12, and with diamagnetism measurement being performed by measuring the time shift or phase shift between the current injected into the first coil 12 and the voltage across this same first coil 12.

FIG. 3 represents a graph illustrating an example of an empirical footprint enabling the diamagnetism measurement to be connected to the oxidation measurement. The graph represented comprises an abscissa axis A corresponding to the intensity introduced into the first coil 12 in arbitrary units. The graph further comprises an ordinate axis B corresponding to the voltage integrated across the second coil 14 in arbitrary units.

The curve C corresponds to an oxidized element 4 while the curve D corresponds to a non-oxidized element 4.

The profile of these curves thus enables the oxidation of an element 4 to be measured by comparison with reference curves, for example the curves C and D.

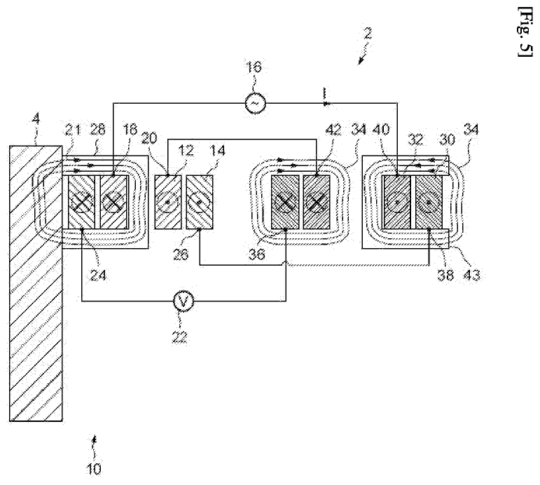

FIG. 4 represents an alternative to the embodiment in FIG. 1, where the magnetic field 21 enters and exits through two different circular faces 6.

FIG. 5 represents a schematic view of a device 2 for measuring oxidation of an element 4 in a second embodiment.

In this second embodiment, only the connections to the power supply 16 differ from the first embodiment.

In this embodiment, the diamagnetism measurement means 10 also comprises a third coil 30 and a fourth coil 32, both intended to be moved away from the element 4 in order to generate a magnetic field 34 in the air.

Each of the coils comprises two terminals. In this embodiment, the connections are such that the means 22 for measuring and integrating the voltage connects, on the one hand, the first terminal 24 of the second coil 14 and a reference terminal, here the reference terminal being the second terminal 36 of the third coil 30.

In addition, the second terminal 26 of the second coil 14 is connected to the first terminal 38 of the third coil 30. The power supply 16 is connected on the one hand to the first terminal 18 of the first coil 12 and on the other hand to the first terminal 40 of the fourth coil 32, the second terminals 20 and 42 of the first and fourth coils 12 and 32 being connected together.

Optionally, the diamagnetism measurement means 10 comprises a guide 43 enabling the magnetic field 34 to be guided directly between the fourth coil 32 and the air, as well as between the air and the third coil 30. For example, the guide 43 is made of ferromagnetic material. For example, it comprises iron and/or nickel. It is similar to the guide 28.

This embodiment is constructed as a mirror construction. This construction makes it possible to implement this embodiment by doubling the device of FIG. 1 in order to perform a measurement in air on the one hand, and in the element 4 on the other hand.

In particular, this embodiment enables a differential measurement to be made between the element 4 and the air, thus providing a more accurate measurement.

The embodiments in FIGS. 1, 4 and 5 are particularly advantageous because they allow the device 2 to be moved closer to the element 4 and thus avoid having to dismantle the brake disc outside the aircraft. In addition, the measurement can be performed when the element 4 is cold or when its temperature is high.

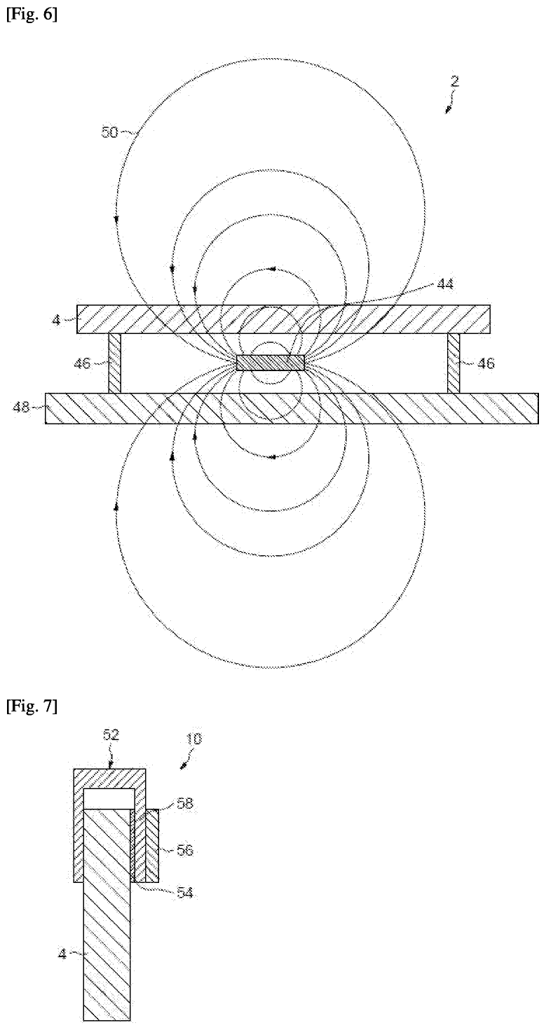

FIG. 6 represents a schematic view of a device 2 for measuring oxidation of a component 4 in a third embodiment.

In this embodiment, the means for converting the diamagnetism measurement into an oxidation measurement is the same as for the previous embodiments. However, the diamagnetism measurement means 10 comprises a magnet 44 and/or an electromagnet, for example a coil, as well as a scale 46 put on a support 48. The element 4 is intended to be put on the scale 46 in proximity to the magnet 44 and/or the electromagnet, for example above or below and without contact.

In FIG. 5, the element 4 is placed above a magnet 44, so that the diamagnetism of the carbon-carbon composite of the element 4 opposes the magnetic field 50 exerted by the magnet 44, making the element 4 appear lighter on the scale 46 than its actual mass. In particular, the heavier the element 4 appears on the scale, the less diamagnetic the element is. An equivalence table and/or a curve footprint and/or a physical law can be used to determine an equivalence between the measured mass and the diamagnetism of element 4. The conversion means then enables the diamagnetism measurement to be converted into an oxidation measurement, the element 4 being therefore oxidized if it appears heavy compared with a non-oxidized element.

FIG. 7 represents a schematic view of a device 2 for measuring oxidation of an element 4 in a fourth embodiment.

In this embodiment, the diamagnetism measurement means 10 comprises a clamping system 52, a strain gauge 54, and a coil 56 integral with the clamping system 52, for example positioned outside a clamp 58 of the clamping system 52. The strain gauge 54 is positioned facing the coil 56, for example inside the clamp 58. The clamp 58 is intended to clamp the element 4 by pressing the strain gauge 54 against the element 4. Supplying the coil 56 creates a magnetic field to which the diamagnetism of the element 4 opposes, generating a force at the strain gauge 54. This force can then be translated into a diamagnetism measurement, for example empirically.

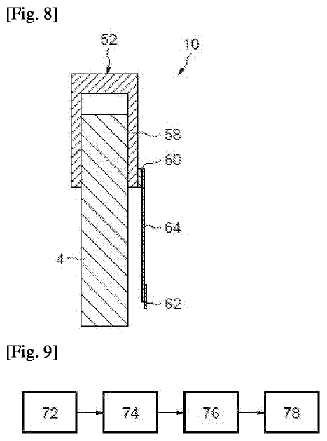

FIG. 8 represents a schematic view of a device 2 for measuring oxidation of an element 4 in a fifth embodiment, the principle of which is similar to the previous two.

In this embodiment, the diamagnetism measurement means 10 comprises a clamping system 52 and a strain gauge 60, for example positioned against the outer surface of a clamp 58 of the clamping system. The diamagnetism measurement means 10 also comprises a coil 62 and a flexible blade 64, the blade being connected to the strain gauge 60 and the coil 62 being positioned on one end of the flexible blade 64.

The clamp 58 is intended to clamp the element 4 by placing the flexible blade 64 and the coil 62 in proximity to the element 4. Supplying the coil 62 creates a magnetic field to which the diamagnetism of the element 4 opposes, thus repelling the coil 62 and distorting the flexible blade 64, thus generating a force at the strain gauge 60. This force can then be translated into a diamagnetism measurement, for example empirically.

The embodiments in FIGS. 7 and 8 are particularly advantageous as they allow the device 2 to be moved closer to the element 4 and thus avoid having to dismantle the brake disc outside the aircraft.

FIG. 9 represents the various steps of the method for measuring oxidation of an element 4 comprising a carbon-carbon composite. This method is implemented using a device 2 according to one of the previous embodiments.

Firstly, a step 72 is performed, of calibrating the device 2 with two reference elements 4, for example a slightly oxidized or non-oxidized element on the one hand, for example a new brake disc, and a highly oxidized element on the other hand, for example a brake disc being worn such that it has to be changed. These reference elements make it possible to create operating threshold values and thus to know whether or not the oxidation measurement is significant at the end of the method.

The method is then repeated on the element 4 to be measured.

In more detail, in a second step 74, the device 2 is moved closer to the element 4.

The diamagnetism measurement means 10 is activated in a third step 76 and the diamagnetism measurement is finally converted into an oxidation measurement in a fourth step 78.

1. A device for measuring oxidation of an element comprising a carbon-carbon composite, characterized in that it comprises a means for measuring diamagnetism of the element and a means for converting the diamagnetism measurement into an oxidation measurement, the diamagnetism measurement means comprising a first coil to be placed in proximity to the element, a power supply supplying the first coil in order to generate a magnetic field, a second coil to be placed in proximity to the element and comprising a first and a second terminal, a means for measuring the voltage between the first terminal of the second coil and a reference terminal so as to measure the variations in magnetic field induced by the element, the diamagnetism measurement means further comprising a third coil and a fourth coil intended to be moved away from the element, each of the coils comprising two terminals, the second terminal of the second coil being connected to the first terminal of the third coil, the second terminal of the third coil being the reference terminal, the power supply being connected on the one hand to the first terminal of the first coil and on the other hand to the first terminal of the fourth coil, the second terminals of the first and fourth coils being connected.

2. The device according to claim 1, wherein the diamagnetism measurement means comprises a guide comprising a ferromagnetic material, the guide guiding the magnetic field generated by the first coil between said first coil and the element.

3. The device according to claim 1, wherein the first and second coils are coaxial.

4. The device according to claim 1, wherein the means for converting the diamagnetism measurement into an oxidation measurement comprises an empirical conversion footprint and/or a theoretical or empirical law establishing an equivalence between diamagnetism of the element and oxidation of the element.

5. A method for measuring oxidation of an element comprising a carbon-carbon composite with a device according to claim 1, characterized in that it comprises the following steps of:
calibrating (step 72) the device with a non-oxidized element and a highly oxidized element;
moving (step 74) the device closer to the element;
activating (step 76) the diamagnetism measurement means; and
converting (step 78) the diamagnetism measurement into an oxidation measurement.
